(19) United States
(12) Patent Application Publication
(10) Pub. No.: US 2017/0248019 A1
(43) Pub. Date: Aug. 31, 2017

(54) HYDROELECTRIC GEAR PUMP WITH VARYING HELIX ANGLES OF GEAR TEETH

(71) Applicant: EATON CORPORATION, Cleveland, OH (US)

(72) Inventor: Matthew Gareld SWARTZLANDER, Battle Creek, MI (US)

(73) Assignee: Eaton Corporation, Cleveland, OH (US)

(21) Appl. No.: 15/513,517

(22) PCT Filed: Sep. 22, 2015
(86) PCT No.: PCT/US2015/051554

§ 371 Date: Mar. 22, 2017

Related U.S. Application Data
(60) Provisional application No. 62/053,547, filed on Sep. 22, 2014.

(51) Int. Cl. F01C 21/08; F01C 13/00; F04C 2/18; F04C 28/04; F03B 13/08; F03B 15/00; F01C 20/04; F04C 14/04; F01C 1/16; F04C 18/18

(52) U.S. Cl. CPC F01C 21/08; F01C 1/16; F01C 13/00; F04C 2/18; F04C 18/18; F03B 13/08; F03B 15/00; F01C 20/04; F04C 14/04; F04C 28/04; F04C 2240/20; F05B 2220/32; F05B 2240/301; F05B 2250/25

(57) ABSTRACT

A gear pump for power generation comprises a first rotor and a second rotor in a case. The first rotor comprises a first plurality of radially spaced teeth, wherein the first plurality of radially spaced teeth wrap around the first rotor helically in a clockwise direction, and wherein at a first position the first plurality of radially spaced teeth have a helix angle different than the helix angle of the first plurality of radially spaced teeth at a second position. The second rotor comprises a second plurality of radially spaced teeth, wherein the second plurality of radially spaced teeth wrap around the second rotor helically in a counter-clockwise direction, and wherein at a first position the second plurality of radially spaced teeth have a helix angle different than the helix angle of the second plurality of radially spaced teeth at a second position.

### TECHNICAL FIELD

The present disclosure relates generally to a gear pump unit for generating hydroelectric power. A bidirectional gear pump unit generates electricity when rotating in a first direction and pumps fluid when rotating in an opposite direction and utilizes helical teeth that vary in helix angle along the axes of the rotors.

### BACKGROUND

By applying the simple concept of using water to turn a turbine that in turn turns a metal shaft in an electric generator, a hydroelectric power generator harnesses energy to generate electricity. The turbine is an important component of the hydroelectric power generator. A turbine is a device that uses flowing fluids to produce electrical energy. One of the parts is a runner, which is the rotating part of the turbine that converts the energy of falling water into mechanical energy.

There are two main types of hydro turbines, impulse and reaction. Impulse turbines use the velocity of the water to move the runner then discharge the water at atmospheric pressure. There is no suction on the down side of the turbine, and the water flows out the bottom of the turbine housing after hitting the runner. An impulse turbine is generally suitable for high-head applications.

Reaction turbines develop power from the combined action of pressure and moving water. The runner is placed directly in a water stream flowing over the blades. Reaction turbines are generally used for sites with lower head than compared with the impulse turbines. Reaction turbines must be encased to contain the water pressure, or they must be fully submerged in the water flow.

Current hydroelectric power generators use centrifugal devices like propellers and impellers in low (<30 m) and medium (30-300 m) head applications. Head is pressure created by the difference in elevation between the water intake for the turbine and the water turbine. Many propeller and impeller type turbines require high-pressure head to perform efficiently, but many geographic locations do not have enough elevation change to create high-pressure head.

To create head, water can be collected or diverted. So, some systems employ a pump to move water so that it can pass through the turbine. This increases the complexity by having one set of pipes and diversion mechanisms aimed at the turbine, and a second set of such equipment for the pump.

A Roots supercharger can be used to operate as both a pump and a generator. But, it is difficult to increase the supercharger's efficiency as a power generator while maintaining its ability to operate as a pump.

### SUMMARY

The present disclosure proposes an improved gear pump and turbine unit that is capable of moving a large volume of water in a bidirectional manner. The unit can operate efficiently in high and low head applications by leveraging attributes of both impulse and reaction turbines. The device is operable fully or partially submerged and can use a siphon effect to operate when not submerged at all. The device can be installed in any orientation, alleviating issues of precise alignment for power generation. To more efficiently generate power, the helix angle of the gear teeth is varied along the axes of the rotors.

In one embodiment, a gear pump unit for hydroelectric power generation comprises a gear pump. The gear pump can comprise a case, which includes a fluid inlet and an outlet. The gear pump comprises a first rotor in the case. The first rotor comprises a rear portion, an axis, a first position located along the axis, a second position located along the axis at a location between the first position and the rear portion, a first plurality of radially spaced teeth, wherein the first plurality of radially spaced teeth wrap around the first rotor helically in a clockwise direction, and wherein at the first position the first plurality of radially spaced teeth have a helix angle different than the helix angle of the first plurality of radially spaced teeth at the second position. The gear pump comprises a second rotor in the case. The second rotor comprises a rear portion, an axis, a first position located along the axis, a second position located along the axis at a location between the first position and the rear portion, a second plurality of radially spaced teeth, wherein the second plurality of radially spaced teeth wrap around the second rotor helically in a counter-clockwise direction, and wherein at the first position the second plurality of radially spaced teeth have a helix angle different than the helix angle of the second plurality of radially spaced teeth at the second position, and wherein the first plurality of teeth mesh with the second plurality of teeth. The gear pump comprises a shaft operatively connected to the first rotor and to the second rotor. The gear pump unit comprises a generator operatively connected to the shaft. The gear pump unit comprises a control module operatively connected to the gear pump and configured to selectively rotate the first rotor in a first direction and to selectively rotate the second rotor in a second direction, the control module further configured to selectively reverse the rotation direction of the first rotor and to selectively reverse the rotation direction of the second rotor.

In another embodiment, a method of operating a hydroelectric power gear pump unit comprises the steps of supplying a fluid to an inlet of a gear pump case, and moving the fluid through a chamber of the case by rotating a first rotor in the case. The first rotor comprises a rear portion, an axis, a first position located along the axis, a second position located along the axis at a location between the first position and the rear portion, a first plurality of radially spaced teeth, wherein the first plurality of radially spaced teeth wrap around the first rotor helically in a clockwise direction, and wherein at the first position the first plurality of radially spaced teeth have a helix angle different than the helix angle of the first plurality of radially spaced teeth at the second position. The method comprises the step of moving the fluid through the chamber of the case by simultaneously rotating a second rotor in the case. The second rotor comprises a rear portion, an axis, a first position located along the axis, a second position located along the axis at a location between the first position and the rear portion, a second plurality of radially spaced teeth, wherein the second plurality of radially spaced teeth wrap around the second rotor helically in a counter-clockwise direction, and wherein at the first position the second plurality of radially spaced teeth have a helix angle different than the helix angle of the second plurality of radially spaced teeth at the second position, and wherein the first plurality of teeth mesh with the second plurality of teeth. The method comprises the steps of expelling the fluid through an outlet of the gear pump case, generating electricity by coupling the rotational energy of the first rotor and the rotational energy of the second rotor to a generator, and reversing the rotating of the first rotor and the second rotor to move the fluid from the outlet to the inlet.

It is to be understood that both the foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate principles of the disclosure.

FIG. 1 is a schematic of a TWIN VORTICES SERIES TVS type supercharger gear pump unit.

FIG. 2 is a schematic of a rotor assembly.

FIG. 3A is a schematic of a high head hydroelectric power generation system.

FIG. 3B is an alternative schematic of a high head hydroelectric power generation system.

FIG. 4 is a schematic of a low head application.

FIG. 5A shows a fluid velocity profile along rotor axes.

FIG. 5B shows a constant relative velocity profile of rotor teeth with respect to a fluid along rotor axes.

FIG. 5C shows a variable relative velocity profile of rotor teeth along rotor axes.

FIG. 5D illustrates rotor axis A2 having system positions overlaid thereon and an exemplary location for helix angles α and β.

FIG. 6 is a schematic of a gear pump with a control module.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts. In this specification, upstream and downstream are relative terms that explain a relationship between parts in a fluid flow environment. Water, when flowing according to natural forces, moves from a first upstream location to a second downstream location. When mechanical means intervene, the flow direction can be altered, so the terms upstream and downstream assist with explaining the natural starting point (upstream) with respect to a location water would naturally, as by gravity, move to (downstream).

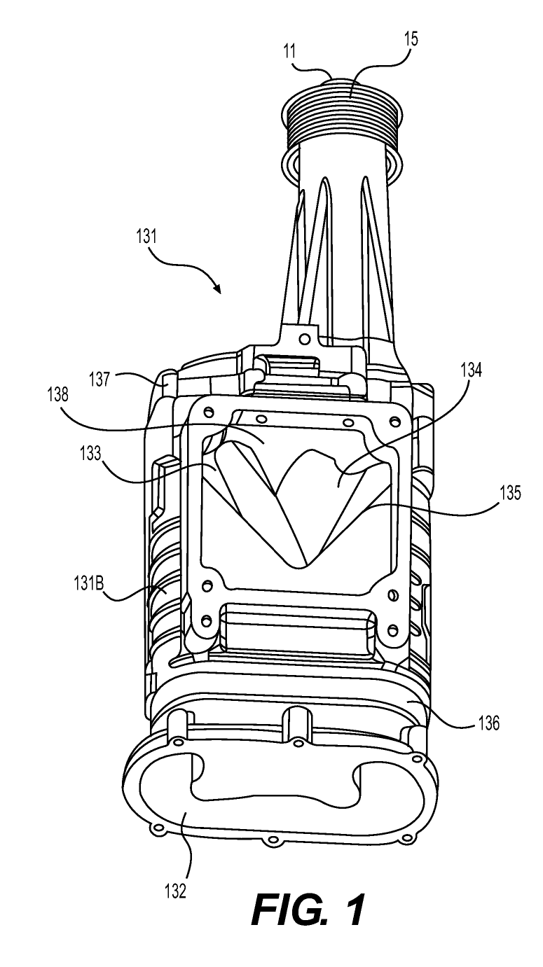

FIG. 1 illustrates one example of a TWIN VORTICES SERIES TVS type supercharger manufactured by Eaton Corporation for connection with a generator and motor. With modification, the TWIN VORTICES SERIES TVS type supercharger can be used as gear pump 131. It is an axial input, radial output type having a pulley hub 15 connected to an internal shaft 11 and transmission gears operatively connecting the internal shaft 11 to rotors 133 and 134. Rotors 133 and 134 rotate inside gear pump case 131B as by mounting the rotors between a bearing plate 138 and a bearing wall 136. The bearing wall includes rotor mounts above the inlet 132 for receiving rotor shafts. The bearing plate includes rotor mounts for receiving rotor shafts and the bearing plate couples to a gear box 137. The gear box 137 houses transmission gears to transfer rotation from the rotors to the shaft 11 and vice versa. Fluid enters inlet 132 and exits outlet 135. Details of a prior art TWIN VORTICES SERIES TVS supercharger can be found in U.S. Pat. No. 7,488,164, incorporated herein by reference in its entirety. While not illustrated, a radial inlet, radial output type supercharger can also be used as gear pump 131, as by moving the axial inlet to a radial side of the case 131B. In FIG. 1, pulleys are used to transfer rotational energy from the pulley hub 15 to a generator or from a motor to pulley hub 15. The pulley hub is operatively connected to a shaft 11 that is operatively connected to rotors 133 and 134. It is alternatively possible to connect the shaft 11 directly to a generator or motor or intermediately via gears or like transfer mechanisms.

To use a supercharger as a gear pump in pump or turbine mode, modifications should be made to the prior art TWIN VORTICES SERIES TVS type supercharger to facilitate maximum efficiency. The prior art design was optimized to compress air for combustion, however, for a hydroelectric generation application, the inlet 132, outlet 135, and rotors 133, 134 must accommodate the incompressible nature of water. Changes that deviate from prior art compression strategies include adjusting the helix angle of the rotors 133, 134 and the timing of inlet 132 and outlet 135. Because the helix angle depends on the twist angle, the twist angle can also be adjusted. The rotors can have a low diametrical pitch to enable large volumes of water to pass through the unit. And, the inlet 132 and outlet 135 port sizes can be adjusted and made larger.

The helix angle can change along the length of the rotors in a smooth or stepwise manner leading to gradual or abrupt alterations in the leading edge of the tooth. While the tooth spacing is largely a function of the number of teeth, the twist angle and the helix angle are dependent upon the primary function of the gear pump: high or low head; pump, siphon, or turbine mode. While discussed in more detail in U.S. Pat. No. 7,488,164, the twist angle is the degree of rotation, from inlet area 22 to rear 23, of the leading edge of the tooth. The twist angle determines how much the tooth wraps around the rotor shaft. The helix angle is the angle that the tooth makes with respect to the center axis of the rotor shaft. The helix angle can change from the tooth root to the tooth leading edge. That is, the helix angle changes in the radial direction of the tooth, from the rotor shaft moving out in diameter to the leading edge. The helix angle can thus affect the cant of the tooth with respect to the center shaft. Because the helix angle changes along the axis A2 and A1, the cross-section profile of the rotor changes from inlet area 22 to rear 23. The increasing helix angle adjusts the angle of the profile of each tooth as the tooth wraps around the rotor shaft.

When in the pump mode, the twist angle of the teeth is designed in consideration of the velocity of water to be handled. Because of the tradeoffs in pressure at the inlet or outlet during turbine or pump mode, the twist angle can be adjusted for a particular hydropower generation system in view of the frequency of use of pump or turbine mode. Despite any particular installation having an optimized preconfiguration, the operating range of the gear pump 131 is greater than traditional turbines because the design of the gear pump 131 can accommodate variable flow rates better than traditional turbines.

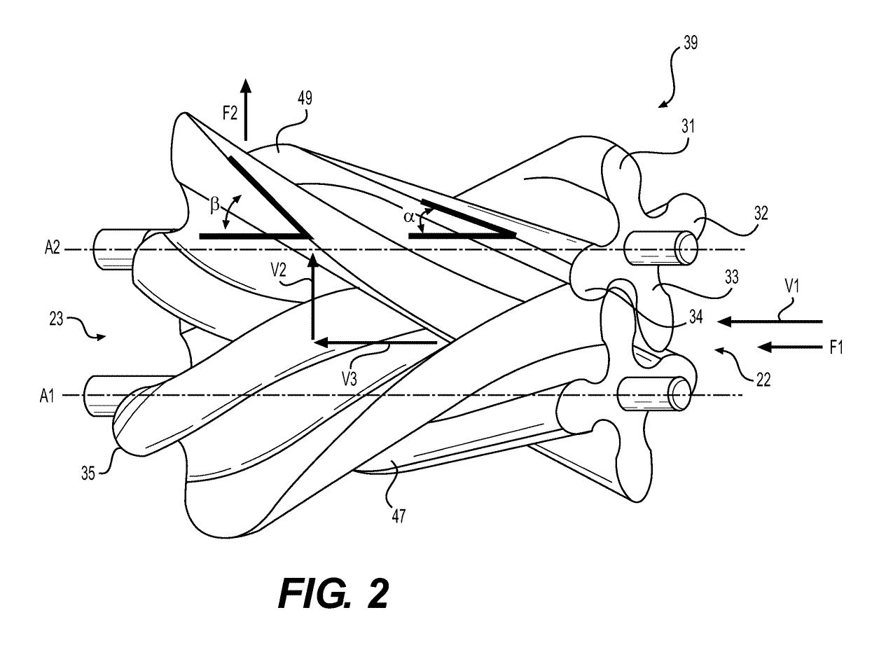

FIG. 2 shows the flow pattern of fluid through a rotor assembly 39 when the gear pump is operating in the power generation mode. Fluid flows into the inlet area 22 in the flow direction F1, then along the rotor axes A1, A2 of rotors 47, 49 then through a radial outlet in the flow direction F2. The flow direction of F2 is perpendicular to the flow direction of F1.

When operating as a pump, the fluid flow reverses direction, thus, the fluid flows through the radial outlet in the opposite direction of flow direction F2, then parallel to the axes A2, A1 in the opposite direction of flow direction F1, and then out the inlet area 22.

In the process of moving fluid from the inlet area 22 to the outlet (shown as 135 in FIG. 1), the incoming fluid has a linear velocity V1, which reduces as it moves through the rotors 47, 49. The rotors mesh together, with the leading edge of a tooth having a linear velocity V3 as it comes in to mesh with a pocket between teeth of the mating rotor. For example, the leading edge of tooth 35 has a linear velocity, or speed at which it meshes between teeth 33 and 32. This linear velocity occurs with respect to the fluid meeting the mesh point, and so the linear velocity of the tooth V3 can be tailored to effectively use the linear velocity of the entering fluid V1. V2 is the linear velocity of the rotor tooth in the radial direction, as by multiplying the lead times the rotational speed.

As the helix angle increases, the linear velocity V3 of the tooth mesh decreases. By adjusting the helix angle along the rotor length, from inlet area 22 to rear 23, the rotor tooth profile can more closely track the decrease in linear velocity of the inlet fluid V1. This improves the supercharger's ability to convert hydraulic velocity to rotational energy and thus generate electricity via the moving fluid. The profile change also accommodates the incompressible nature of moving water, as the supercharger is no longer limited to blowing a compressible fluid, such as air.

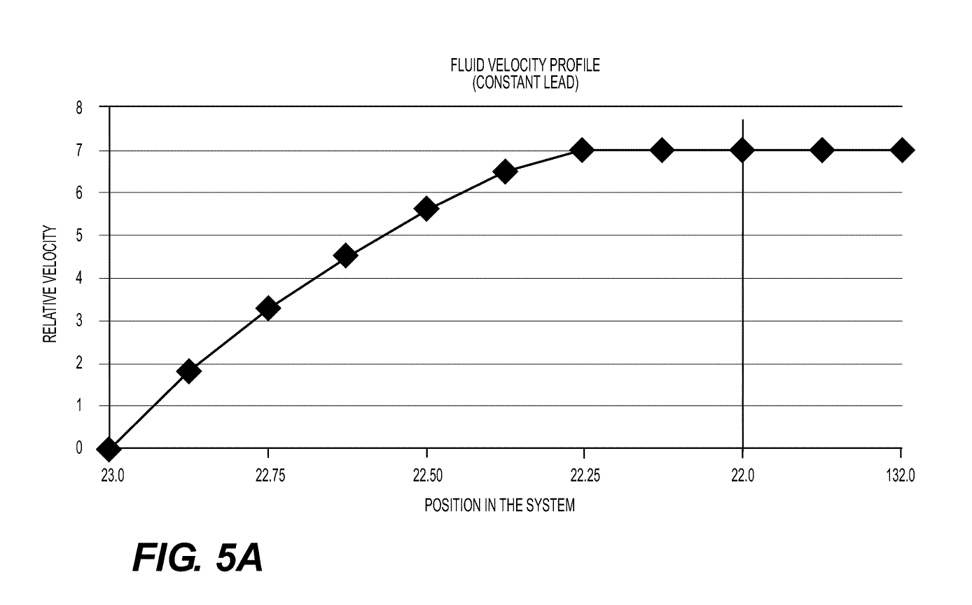

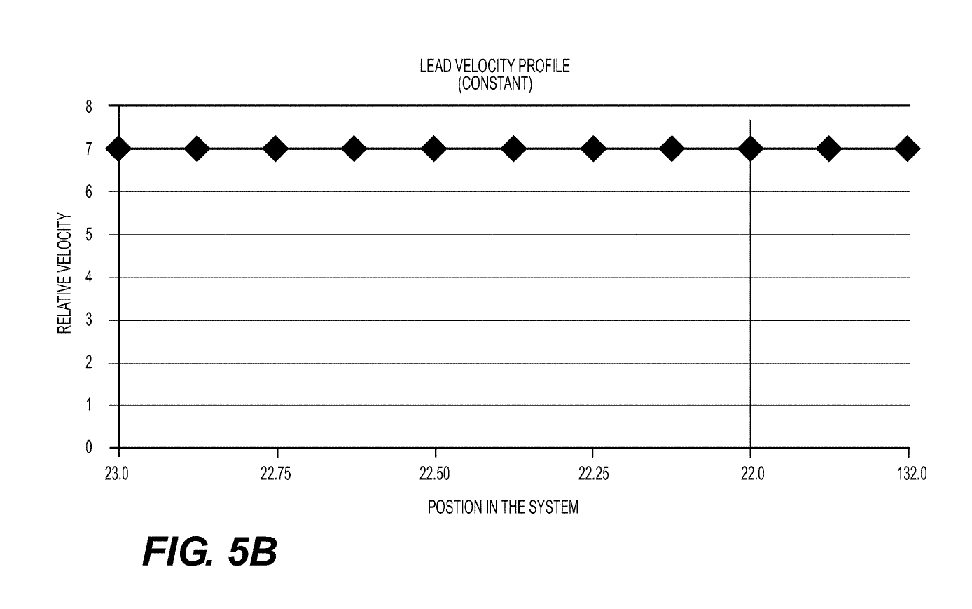

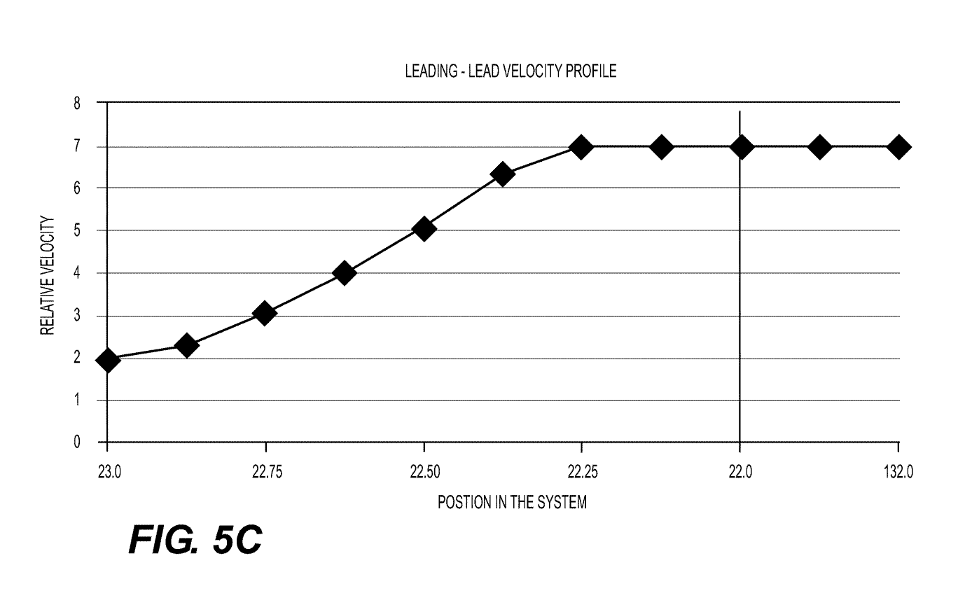

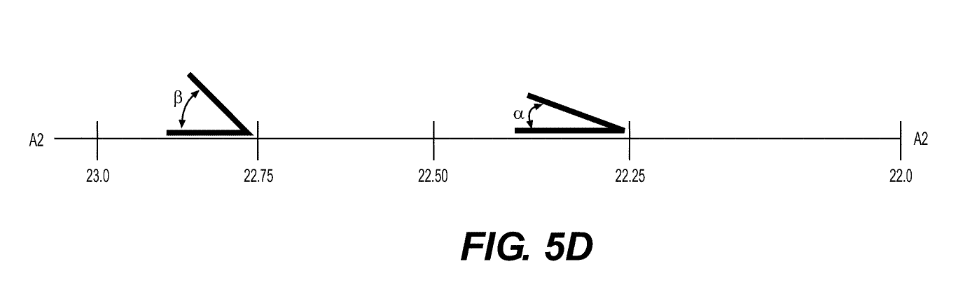

Turning to FIG. 5D, the axis A2 is shown for an example of positions within the rotor system. On the left, the bearing plate would adjoin the rear position 23.0 of the rotor and on the right, the inlet area position 22.0 would adjoin the bearing wall 136. Spaced along the axis A2, between the rear position 23.0 and the inlet area position 22.0 are other positions, 22.75, 22.50, 22.25. Also noted are examples for the vertices for helix angles α, β.

Turning to FIG. 5A, fluid travels at linear velocity V1 from a duct position 132.0 to inlet area position 22.0. When the lead of the tooth is constant (thus the helix angle is constant), the velocity of the fluid decreases relative to the tooth along the length of the rotor. Because the leading edge has a constant helix angle, V3 remains constant even as the fluid slows along flow direction F1, and so FIG. 1 shows that, relative to the linear velocity of the tooth V3, the fluid slows from inlet area position 22.0 to rear position 23.0. The leading edge is constant, and so the lead velocity profile for V3 is constant relative to the fluid flow. The teeth mesh at a constant linear velocity V3 despite the fluid slowing.

However, ideally, the leading edge of the rotor would keep a constant relative linear velocity V3 with respect to the linear velocity of the fluid V1. FIG. 5C shows one example of a rotor having a varying helix angle, where the helix angle increases from inlet area position 22.0 to rear position 23.0. The velocity of the leading edge of the tooth slows from point to point from inlet area position 22.0 to rear position 23.0, and the relative difference between the two linear velocities decreases along the rotor length. This design more efficiently captures hydroelectric power.

When operating as a power generator, the velocity of the fluid entering the inlet area 22 is different than the velocity of the fluid at locations approaching the rear 23. The fluid slows from its maximum velocity at the inlet area 22 to its minimum velocity (which can be zero as it impacts the bearing plate) at the rear 23. The velocity profile is not linear. An example of the linear fluid velocity profile can be seen in FIG. 5A. FIG. 5A shows that the fluid velocity is at a maximum at the duct to the inlet area 22.

Rotor 47 has four radially spaced teeth 31, 32, 33, 34. The invention, however, is not limited to having four teeth. One skilled in the art would recognize that the rotors could be designed with more or less teeth, such as 2-5 teeth. Also, the teeth could be hollow, solid, or partially solid. The teeth could also be made of many materials, including metal, plastic, a composite, or other materials.

A gear pump having rotor teeth with the same helix angle along the axis of the rotor does not generate power in the most efficient manner. Energy losses occur because the velocity of the fluid does not match the relative velocity of the rotor teeth at locations along the axis of the rotor.

The relative velocity of the rotor teeth of a gear pump having the same helix angle along axes A1, A2 is shown in FIG. 5B. The relative velocity at the inlet area 22 (position 8) is the same as the relative velocity of the rotor teeth at the rear 23 (position 0) and is the same at every position in between the rear 23 and the inlet area 22. The helix angle α is the same as the helix angle β in this arrangement. The helix angle at any given point along the axis of the rotor is the angle between the tooth (e.g. helix of tooth 34) and the axis (e.g. A2) of the rotor. Thus in FIG. 2, α is the angle between the tooth 34 and axis A2. The relative velocity, or velocity of the fluid with respect to the leading edge of the tooth, is the same because the helix angle is the same at each position along the axis of the rotor. The rotor teeth are moving at the same velocity relative to the fluid at each position along the axis of the rotor.

A device with the relative velocity profile shown in FIG. 5B would match the velocity of a fluid at one location along the rotor because the relative velocity profile of the rotor tooth is constant while the velocity of the fluid is continuously decreasing in a nonlinear manner. Energy losses occur when the rotor tooth is moving at a velocity different than the velocity of the fluid.

The relative velocity profile can be changed by varying the helix angle of the rotor teeth along the axis of the rotor. A lower helix angle results in a higher linear velocity V3. A higher helix angle results in lower linear velocity V3. A gear pump having the relative velocity profile of FIG. 5C would have a helix angle α less than the helix angle β at the axial positions of angles α and β as shown in FIGS. 2 and 5D.

FIG. 5C shows the relative velocity profile of one embodiment where the helix angle increases from its minimum angle at the inlet of the pump to its maximum angle at the rear of the pump. As the velocity of fluid decreases along the length of rotors 47, 49, the pressure of the fluid changes. By adjusting the helix angle of an individual tooth (e.g. 31, 32, 33, or 34) along the length of the rotor, the positive displacement pump is better able to harness the energy of the fluid for conversion to electricity. As shown in FIG. 5C, the lead velocity V2 of the tooth is high and the velocity of the water is high at the inlet area position 22.0. This spins the tooth quickly for harnessing the power of the water, as the tooth rotation is transferred to a generator. The helix angle increases as the water moves towards the bearing plate position 23.0, which slows the lead velocity to more closely match the slowing water. While in the example the lead velocity V2 does not reach the possible zero velocity of the water, the tooth lead is better matched to the water velocity, which improves system performance over a constant helix angle design. By implementing the helix angle variations along the rotor length, the velocity profile of the lead is closer to the velocity profile of the water and system performance is improved.

FIG. 5A is only one example of a fluid velocity profile flowing through the gear pump. The fluid velocity profile could change depending on many factors, including the type of fluid (e.g. water, air, oil), the density of the fluid, the viscosity of the fluid, the pressure of the fluid as it enters the device, the pressure of the fluid as it exits the device, and the temperature of the fluid.

In other examples, the helix angles of the gear teeth can be varied in a manner to more closely fit the velocity profile of the fluid passing through the device. For example the fluid velocity can decrease at a different rate or at a different profile than illustrated in FIG. 5A. In other examples, the fluid velocity could decrease more rapidly. The rate of change of the helix angle can be stepwise or smoothed, and the rate of change can increase or decrease at different rates along the rotor length. The steepness of the rate of change can be varied for a particular application, and is not limited to the example of FIG. 5C.

Also, one designing the gear pump might consider how often the gear pump is used for power generation versus how often the gear pump is used to pump fluid to, for example, a reservoir. The most efficient velocity profile for generating power does not necessarily equal the most efficient profile for pumping fluid.

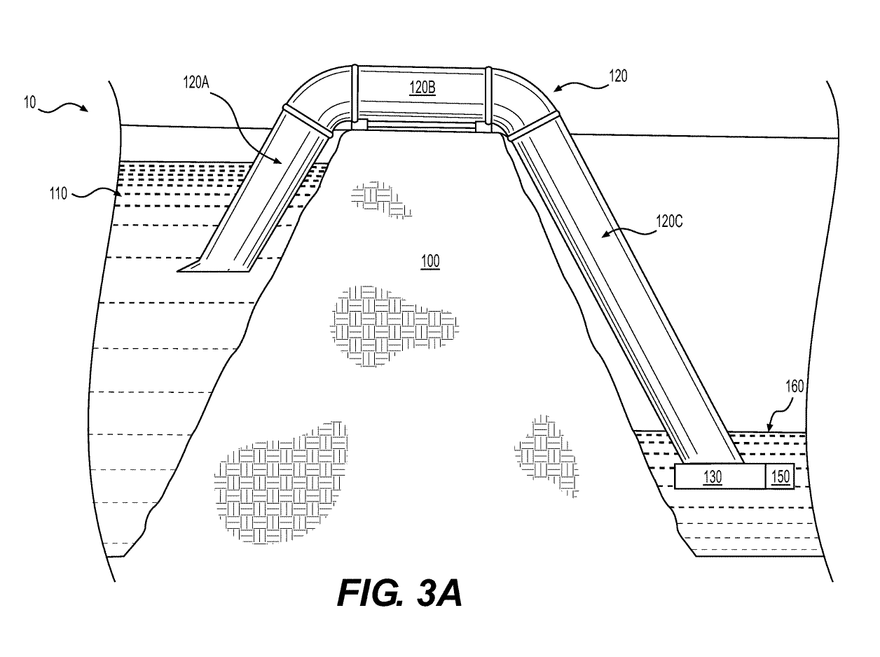

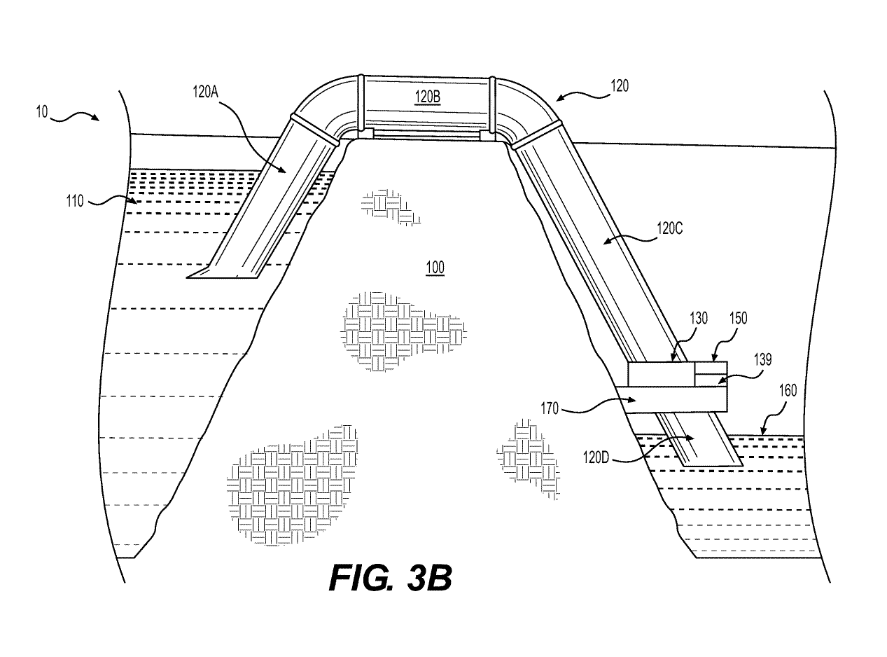

FIG. 3A shows a schematic view of hydroelectric power generation system 10. In this example, system 10 is a high-head system with a dam 100 forming a reservoir 110 of water. System 10 comprises a penstock 120 and a gear pump unit 130. The penstock 120 can be a tube like structure that extends from upstream of the gear pump unit 130 to the gear pump unit 130. The penstock 120 is a conduit for water. The penstock 120 can be divided into three main parts. A first leg 120A of the penstock 120 is placed in reservoir 110. Reservoir 110 is located in an upstream portion of a river 160. Top, or second leg, part 120B of the penstock 120 is located on the top of a dam 100. The third leg 120C of the penstock 120 is located on a downstream side of reservoir 110. The third leg 120C is extended to an inlet port (for example, inlet 132 of FIG. 1) of the gear pump unit 130 to supply water. The gear pump unit 130 is connected to the penstock 120 to pump water upstream to return water to the reservoir 110 when in pump mode. Further, the gear pump unit 130 can operate in a turbine mode to generate hydroelectricity using the water coming through the penstock 120 from the reservoir 110 to the river 160. A siphon mode can be implemented to initiate turbine mode. The gear pump 130 can be submerged in water as shown, or can be out of the fluid. As shown in FIG. 3B, a platform 170 supports the gear pump unit 130 above the river 160 and a tailrace, or fourth leg 120D, extends out of gear pump unit 130 in to river 160. The fourth leg 120D can be alternatively included on the submerged embodiment of FIG. 3A. As a further alternative, penstock 120 can be partially or fully embedded in dam 100.

The gear pump unit 130 is scalable for pumping air, water, or mixtures of air and water. The gear pump unit 130 is a positive displacement pump modeled on a Roots supercharger. Compared to an automotive supercharger, the inlet and outlet ports are adjusted for providing fluid flow with minimal or no compression. The rotor angles are also adjusted for accommodating the velocity of the water, which is based on the available head. Unlike the prior art turbines, that cannot process mixtures of air and water, gear pump 130 does not need a pure water stream to operate in turbine or pump modes.

The gear pump unit 130 is bidirectional, meaning it can receive water from the reservoir 110 and expel it to river 160. The gear pump unit 130 can also siphon from the river 160 and pump fluid back to the reservoir 110. The gear pump unit 130 can also operate in turbine mode to generate electricity.

When operating in a forward pump mode, the gear pump unit 130 draws up water from the reservoir 110 through leg 120A of penstock 120, and then supplies the same to the leg 120C of penstock. More specifically, once the gear pump unit 130 is activated, it can suck water up the leg 120A. The water travels through second leg 120B, which can be embedded in dam 100 or fitted or retrofitted to the top of the dam 100, as shown. The suction by gear pump unit 130 draws the water through third leg 120C. Once sufficient fluid is drawn in to third leg 120C, then the gear pump unit 130 can cease sucking water in to the penstock 120. So long as first leg 120A remains submerged in water, siphon effect will supply water from the reservoir 110 to the gear pump unit 130 through the penstock 120. Thus, gear pump unit 130 converts from forward pumping mode to turbine mode once siphon effect is established. Should the need arise, gear pump unit 130 can operate in pump mode even after siphon effect is established, for purposes such as pumping down reservoir 110. Instead of employing a turbine, forward pump and reverse pump, gear pump unit 130 consolidates three functions in to one unit. Outlay is greatly simplified.

By employing a control module 150, the gear pump unit 130 can receive electronic commands to operate in forward, reverse, or turbine modes. Inclusion of sensors in the control module 150 enables feedback control.

Although the placement of penstock 120 in FIG. 3A is shown to be around the dam 100 and in open air, it is not restricted as such. The penstock 120 can also be placed below the water level, fully submerged. Thus the gear pump unit 130 and penstock 120 can be installed in the original dam 100 infrastructure, or it can be retrofitted, or it can be installed directly in a river. It can replace original installation, or supplement its capacity.

The gear pump unit 130 can be constructed as a component of the hydropower generation system 10 as described in FIG. 3A. In addition, the gear pump unit 130 can supplement an existing hydropower generation plant by being a modular installation. In supplementing the existing hydropower generation plant, the gear pump unit 130 can simply replace the existing turbine to enhance the efficiency of the existing system. Alternatively, the gear pump unit 130 can be simultaneously used with the existing turbine and pump, as by being laid over the existing infrastructure.

FIG. 3B illustrates another benefit of the modular design, which enables easy servicing and maintenance. A platform 170 is installed at or near the water level of river 160. The gear pump unit 130 and control module 150 are stationed on the platform 170. The gear pump unit 130 is serviceable and the control module 150 is easily updated. A computing device 139 can be in communication with the control module 150. The computing device 139 can include a network of sensors, a processor, a memory, and stored algorithms. The computing device 139 can be configured to emit commands to the control module 150 to operate the gear pump 130 in one of a turbine mode, a suction mode, or a pump mode. Being externally mounted to the dam 100, it is not necessary to enter in to the dam 100 to service the penstock 120 or gear pump unit 130. The light weight of a gear pump with hollow rotors further facilitates the modular design. Computing device 139 can be remotely mounted with transceiver capabilities linked to control module 150.

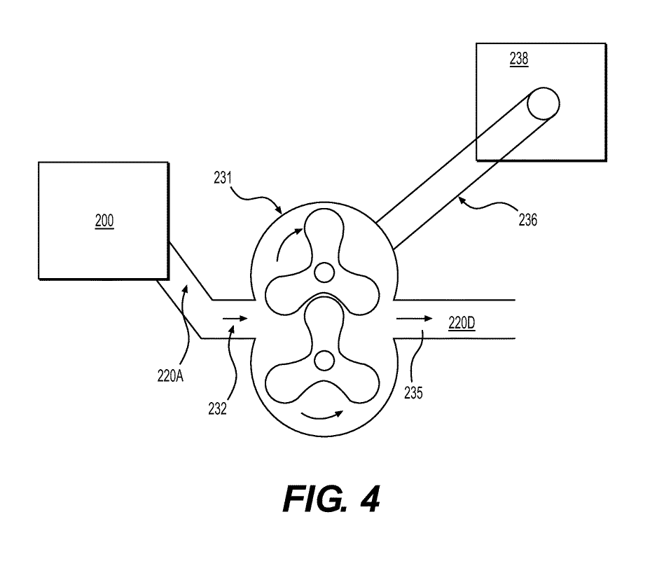

FIG. 4 shows another embodiment of the present invention. A gear pump 231 is placed in a small stream to generate electricity. The gear pump 231 can be a low head hydroelectric power generator. The gear pump 231 can receive water from a water source 200 through an inlet 232. The water source 200 can be a canal or fast flowing river or stream. The gear pump unit 230 comprises a gear pump 231 and a generator 238. The gear pump 231 and the generator 238 can be connected to each other through a pulley device 236 or by a shaft or gears or other mechanical coupling. The gear pump unit 230 can be constructed similar to the gear pump unit 130 as described using FIG. 2, with additional modifications to accommodate the difference in fluid velocity in the low head application, such as underwater placement of penstock 220A leading to inlet 232, and inclusion of tailrace penstock 220D at outlet 235. The gear pump 231 can alternatively include another fluid diversion mechanism than a penstock, such as a tray like structure.

The gear pump 231 can be completely submerged under the water level of a flowing water source, or can be partially submerged. If fluid flow is not sufficient to turn the turbine, power can be used to pump up the water source by operating in pump mode and filling a reservoir structure. Thus, in the low head application it is particularly advantageous to implement a combined generator/motor. However, when a reservoir is not necessary, and fluid flow is sufficient, gear pump 231 can be used without a costly structural base making it cost effective and portable.

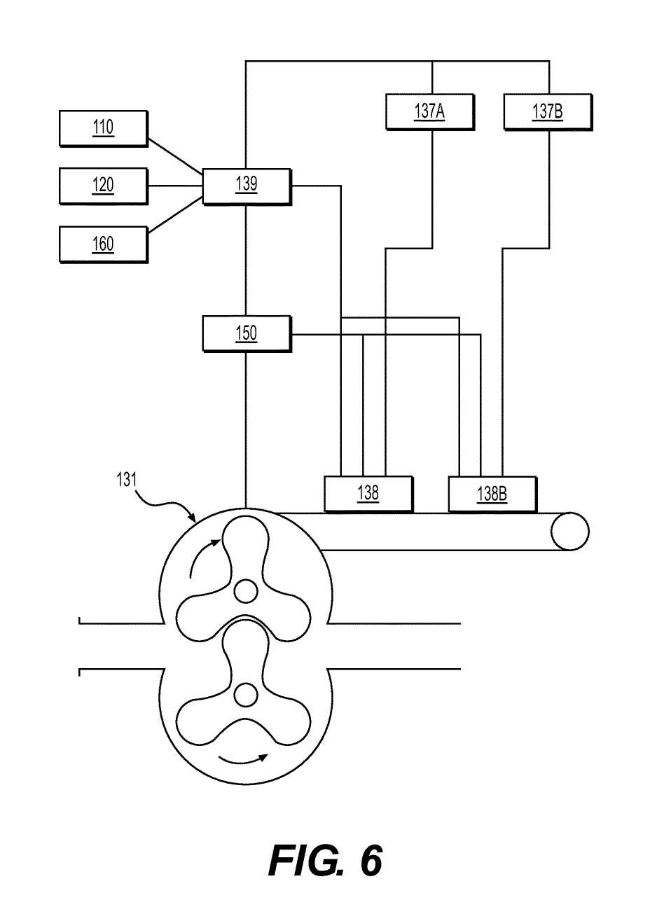

FIG. 6 shows a schematic of a gear pump 131 with a control module 150. By employing a control module 150, the gear pump 131 can receive electronic commands to operate in forward, reverse, or turbine modes. Inclusion of sensors in the control module 150 enables feedback control. A variety of control electronics, such as wiring, sensors, transmit, receive, computing, computer readable storage devices, programming, and actuator devices, can be devised to implement control module 150. Programming implements modes of operation to control gear pump 131, such as to perform the pump function during off peak time and to perform the turbine mode during peak time.

The computing device 139 controls the gear pump 131 by commanding that the control module 150 operate the gear pump 130 in one of turbine mode, suction mode, or pump mode. The implementation of the computing device 139 can differ from one hydroelectric power generation system to the other. For instance, the computing device 139 can be operated based on strict time. In other words, by setting a peak hour and off-peak hour, the gear pump unit can strictly conduct a certain operation during the designated time.

Alternatively, the computing device 139 can operate to change the mode based on feedback it receives. In view of this, gear pump 131 and computing device 139 can include a network of additional electronics such as an array of additional sensors. The sensors could include, for example, electricity sensors in grid 137A and battery 137B, water level sensors in the reservoir 110, velocity sensors in penstock 120, RPM (rotations per minute) speed sensors in the gear pump 131, speed sensors in generator 138, and water level sensors in river 160. Such sensors can electronically communicate with a computing device 139 having a processor, memory, and stored algorithms. The computing device 139 can emit control commands to the gear pump 131 to operate in passive (turbine), forward (suction), or reverse (pump) modes. The computing device 139 can also send a signal to motor 138B, telling it to power the gear pump in either forward (suction) or reverse (pump) modes.

The computing device 139 can be located with the gear pump 131, or remote from the gear pump with appropriate communication devices in place. Based on feedback, such as low electricity in the battery, the gear pump 131 can operate in suction mode to fill the penstock 120, and can then switch to turbine mode to charge the battery. Or, if a water level sensor in reservoir 110 indicates low water level, the gear pump 131 can operate in pump mode to move water from river 160 to the reservoir 110.

In the preceding specification, various preferred embodiments have been described with reference to the accompanying drawings. It will, however, be evident that various other modifications and changes can be made thereto, and additional embodiments can be implemented, without departing from the broader scope of the invention as set forth in the claims that follow. The specification and drawings are accordingly to be regarded in an illustrative rather than restrictive sense.

1. A gear pump unit for hydroelectric power generation, comprising:
a gear pump comprising:
a case comprising a fluid inlet and an outlet;
a first rotor in the case, the first rotor comprising:
a rear portion;
an axis;
a first position located along the axis;
a second position located along the axis at a location between the first position and the rear portion;
a first plurality of radially spaced teeth, wherein the first plurality of radially spaced teeth wrap around the first rotor helically in a clockwise direction, and wherein at the first position the first plurality of radially spaced teeth have a helix angle different than the helix angle of the first plurality of radially spaced teeth at the second position;
a second rotor in the case, the second rotor comprising:
a rear portion;
an axis;
a first position located along the axis;
a second position located along the axis at a location between the first position and the rear portion;
a second plurality of radially spaced teeth, wherein the second plurality of radially spaced teeth wrap around the second rotor helically in a counter-clockwise direction, and wherein at the first position the second plurality of radially spaced teeth have a helix angle different than the helix angle of the second plurality of radially spaced teeth at the second position, and wherein the first plurality of teeth mesh with the second plurality of teeth; and
a shaft operatively connected to the first rotor and to the second rotor;
a generator operatively connected to the shaft; and
a control module operatively connected to the gear pump and configured to selectively rotate the first rotor in a first direction and to selectively rotate the second rotor in a second direction, the control module further configured to selectively reverse the rotation direction of the first rotor and to selectively reverse the rotation direction of the second rotor.

2. The gear pump unit of claim 1, wherein at the first position the first plurality of radially spaced teeth have a helix angle less than the helix angle of the first plurality of radially spaced teeth at the second position.

3. The gear pump unit of claim 2, wherein at the first position the second plurality of radially spaced teeth have a helix angle less than the helix angle of the second plurality of radially spaced teeth at the second position.

4. (canceled)

5. (canceled)

6. The gear pump unit of claim 3, wherein, when the control module selectively rotates the first rotor in the first direction and selectively rotates the second rotor in the second direction, and when an inlet fluid is supplied to the inlet, the fluid moves from the inlet to the outlet in respective gaps between the first plurality of radially spaced teeth and in respective gaps between the second plurality of radially spaced teeth, and wherein, when the control module selectively reverses the rotation direction of the first rotor and selectively reverses the rotation direction of the second rotor, and wherein a tailrace fluid is supplied to the outlet, the tailrace fluid moves from the outlet to the inlet in the respective gaps between the first plurality of radially spaced teeth and in the respective gaps between the second plurality of radially spaced teeth.

7. The gear pump unit of claim 3, wherein the fluid is air, water, or a mixture of air and water, and wherein the fluid moves in the gear pump without cavitation.

8. The gear pump unit of claim 3, further comprising a penstock fluidly coupled to the inlet.

9. The gear pump unit of claim 8, wherein the penstock comprises:
a first leg in a reservoir;
a second leg on a dam; and
a third leg connected to the gear pump,
wherein the dam comprises a platform, wherein the gear pump is mounted on the platform, and wherein the gear pump is not submerged.

10. (canceled)

11. The gear pump unit of claim 3, further comprising a computing device in communication with the control module, the computing device further comprising a network of sensors, a processor, a memory, and stored algorithms, the computing device configured to emit commands to the control module to operate the gear pump in one of a turbine mode, a suction mode, or a pump mode.

12. The gear pump unit of claim 3, wherein the first plurality of radially spaced teeth comprises teeth in the range of 2-5, and wherein the second plurality of radially spaced teeth comprises teeth in the range of 2-5.

13. The gear pump unit of claim 12, wherein each tooth of the first plurality of radially spaced teeth and each tooth of the second plurality of radially spaced teeth comprises a diameter of 25 to 50 inches.

14. The gear pump unit of claim 3, wherein the gear pump is an axial-input, radial-outlet type supercharger.

15. The gear pump unit of claim 3, wherein each of the first plurality of radially spaced teeth and each of the second plurality of radially spaced teeth are hollow.

16. The gear pump unit of claim 3, wherein the helix angle of the first plurality of teeth and the helix angle of the second plurality of teeth changes in a stepwise manner.

17. The gear pump unit of claim 3, wherein the helix angle of the first plurality of teeth and the helix angle of the second plurality of teeth changes in a smooth manner.

18. A method of operating a hydroelectric power gear pump unit comprising the steps of:
supplying a fluid to an inlet of a gear pump case;
moving the fluid through a chamber of the case by rotating a first rotor in the case, the first rotor comprising:
a rear portion
an axis;
a first position located along the axis;
a second position located along the axis at a location between the first position and the rear portion;
a first plurality of radially spaced teeth, wherein the first plurality of radially spaced teeth wrap around the first rotor helically in a clockwise direction, and wherein at the first position the first plurality of radially spaced teeth have a helix angle different than the helix angle of the first plurality of radially spaced teeth at the second position;
moving the fluid through the chamber of the case by simultaneously rotating a second rotor in the case, the second rotor comprising:
a rear portion;
an axis;
a first position located along the axis;
a second position located along the axis at a location between the first position and the rear portion;
a second plurality of radially spaced teeth, wherein the second plurality of radially spaced teeth wrap around the second rotor helically in a counter-clockwise direction, and wherein at the first position of the second rotor the second plurality of radially spaced teeth have a helix angle different than the helix angle of the second plurality of radially spaced teeth at the second position of the second rotor, and wherein the first plurality of teeth mesh with the second plurality of teeth;
expelling the fluid through an outlet of the gear pump case;
generating electricity by coupling the rotational energy of the first rotor and the rotational energy of the second rotor to a generator; and
reversing the rotating of the first rotor and the second rotor to move the fluid from the outlet to the inlet.

19. The method of claim 18, wherein at the first position the first plurality of radially spaced teeth have a helix angle less than the helix angle of the first plurality of radially spaced teeth at the second position.

20. The method of claim 18, wherein at the first position of the second rotor, the second plurality of radially spaced teeth have a helix angle less than the helix angle of the second plurality of radially spaced teeth at the second position of the second rotor.

21. The method of claim 20, wherein the step of supplying the fluid to the inlet further comprises supplying the fluid to a first leg of a penstock, and wherein the method of operating a hydroelectric power gear pump unit further comprises the step of operating the gear pump to siphon the fluid in to the first leg of the penstock.

22. The method of claim 20, wherein the step of reversing the rotating of the first rotor and the second rotor further comprises the step of operating the gear pump to siphon the fluid in to the gear pump.

23. The method of claim 20, wherein the helix angle of the first plurality of teeth and the helix angle of the second plurality of teeth changes in a stepwise manner.

24. (canceled)
